(19) United States
(12) Patent Application Publication
(10) Pub. No.: US 2003/0074988 A1
(43) Pub. Date: Apr. 24, 2003

(54) Pipette device

(76) Inventors: Osmo Suovaniemi, Helsinki (FI); Pertti Ekholm, Helsinki (FI)

Correspondence Address: BIRCH STEWART KOLASCH & BIRCH, PO BOX 747, FALLS CHURCH, VA, 22040-0747, US

(21) Appl. No.: 10/177,126

(22) Filed: Jun. 24, 2002

(30) Foreign Application Priority Data
Jul. 6, 2001 (FI) U20010274

(51) Int. Cl. B01L 3/02; G01N 1/14

(52) U.S. Cl. 73/864.14

(57) ABSTRACT

A pipette for use with disposable tips and having ejector and actuating devices for detaching the disposable tips from the pipette. The actuating device includes at least one cam element for interacting with the ejector, connected to the pipette body by a pivotal joint. The mechanism makes it possible to vary the torque conversion ratio of the cam element throughout the operation cycle of the actuator. It is particularly well suited for use with a multi-tip device in which the force required for tip ejection is larger than in single tip devices.

The invention relates to a suction device comprising a body with a tip part, said tip part having a distal end suited for mounting thereon a disposable pipette tip by a tight friction fit, ejector means adapted to perform a movement in the direction of the longitudinal axis of the pipette device between the distal end of the disposable pipette tip and the upper portion of the body, and at least one actuating means located in the upper portion of the body and cooperating with said pipette tip ejector means so as to accomplish said movement in the direction of the longitudinal axis of the pipette device.

Conventional pipette devices intended for dispensing liquids utilize disposable pipette tips that are removably attachable to the tip part of the body of the pipette device. Generally, the pipette tips are mounted to the pipette device tip part by a tight friction fit. Most ones of pipette device embodiments also incorporate means for ejecting their disposable pipette tips without manually touching the pipette tips.

FI Patent No. 57540 discloses a mechanism for ejecting the disposable pipette tip. Analogously to certain other prior arrangements, also in this embodiment the pipette tip ejector mechanism comprises an ejector sleeve, an actuating lever arm connected to the ejector sleeve for moving the ejector sleeve and a toggle lever member mounted at the end of the actuating lever. The actuating lever arm is connected to the pipette device body by suitable members or, alternatively, the body is provided with connection members suited for actuating the lever arm. The pipette tip ejector mechanism also includes spring elements for returning the tip ejector sleeve and its actuating lever arm to their home position, wherein a new disposable pipette tip can be mounted on the pipette device tip part.

The embodiment described in the above-cited FI Pat. No. 57540 has the travel distance of the pipette tip ejector with its actuating lever arm made equal to the distance required to eject the pipette tip. Herein, a force is required for pipette tip ejection that must exceed the static friction force keeping the disposable pipette tip mounted on the tip part of the pipette device. The manual force necessary for pipette tip ejection may be substantially high, even so as to cause a stress injury to the user of the pipette device. After the static friction of the disposable pipette tip ejection is overcome, the manual ejection force falls drastically, which typically annoys the user. Especially in multi-tip pipette devices the above-described shortcomings are accentuated due to the large number of pipette tips.

In U.S. Pat. No. 5,435,197 is disclosed another design for ejecting a disposable pipette tip mounted on the tip part of a pipette device by a tight friction fit. The embodiment of a pipette tip ejector mechanism disclosed in this publication comprises an ejector sleeve adapted to move on the pipette device tip part so as to make contact to the proximal end of the disposable pipette tip. To the upper part of the ejector sleeve is connected a link arm extending from the tip part of the pipette device to the top part thereof. To the upper end of the link arm is pivotally attached a lever arm having its proximal end supported on the body and its distal end projecting outwardly from the body. Then, a downward push on the distal end of the lever arm causes the link arm to move downward, whereby also the ejector sleeve moves downward so as to eject the disposable pipette tip. While the proximal end of the link arm can rotate inside the body so as to be supported by a backing surface, the same backing surface also serves to prevent an upward motion of the lever arm proximal end. The publication also discloses an embodiment, wherein the proximal end of the lever arm, which is pivotally to the connected to the link arm, is shaped into a toothed gear meshing with a toothed rack made to the body. A pressing force applied to the distal end of the lever arm causes the toothed gear to move downward along the toothed rack of body, whereby also the link arm is forced to move downward. Additionally, the publication discloses some modifications of the above-described embodiments, all of them having in common that the link arm is pivotally connected to the lever arm and that the proximal end of the lever arm in a way or another is supported on the pipette device body.

Accordingly, the embodiment disclosed in the above-referenced U.S. Pat. No. 5,435,197 uses a conventional lever arm, whereby an actuating force inflicted on the distal end of the lever arm imposes at all angular positions of the lever arm a constant force on the link arm that is connected to the pivot point.

State-of-the-art embodiments typically have only one link arm adapted to operate within the shell of the pipette device body between the pipette tip ejector sleeve and the ejector pushbutton. Hereby, the force imposed on the ejector sleeve and, hence, on the disposable pipette tip via the ejector sleeve is not generally distributed evenly on the proximal end of the disposable pipette tip mounted on the pipette device. Resultingly, the pipette device body and/or its other support members are subjected to an asymmetric stress. Furthermore, since the ejection-actuating force inflicted on the end of the link arm is not necessarily transmitted parallel to the direction of the longitudinal axis of the disposable pipette tip so as to be imposed evenly about the perimeter of the disposable tip, the actuating force needed for disposable pipette tip ejection becomes larger than in the case of having the ejection force distributed evenly on the proximal end of the disposable pipette tip.

The embodiment according to the invention is characterized in that said at least one actuating means comprises a cam element connected to the body of the pipette device by means of a pivotal joint and having an at least partially arcuate cam surface suited to make contact with the top surface of said pipette tip ejector means so as to move said pipette tip ejector means in the direction of the longitudinal axis of the pipette device for ejecting said disposable pipette tip from the distal end of the pipette device tip part.

The arrangement according to the invention makes it possible to vary the torque conversion ratio of the cam element in different angular positions of the actuating means. The torque conversion ratio can be designed to change so that in the initial ejection phase of the disposable pipette tip, wherein the static friction between the disposable pipette tip and the tip part of the body must be overcome, the cam element is moved over a relatively large angle of rotation about its pivot point whereas this actuation moves the ejector rod only a short distance downward.

The embodiment according to the invention is particularly well suited for use in multipipette devices in which the ejection force of a set of disposable pipette tips due to the large number of the disposable tips is higher than in single-tip pipette devices.

Next, some preferred embodiments of the invention are described in more detail by making reference to the appended drawings, in which

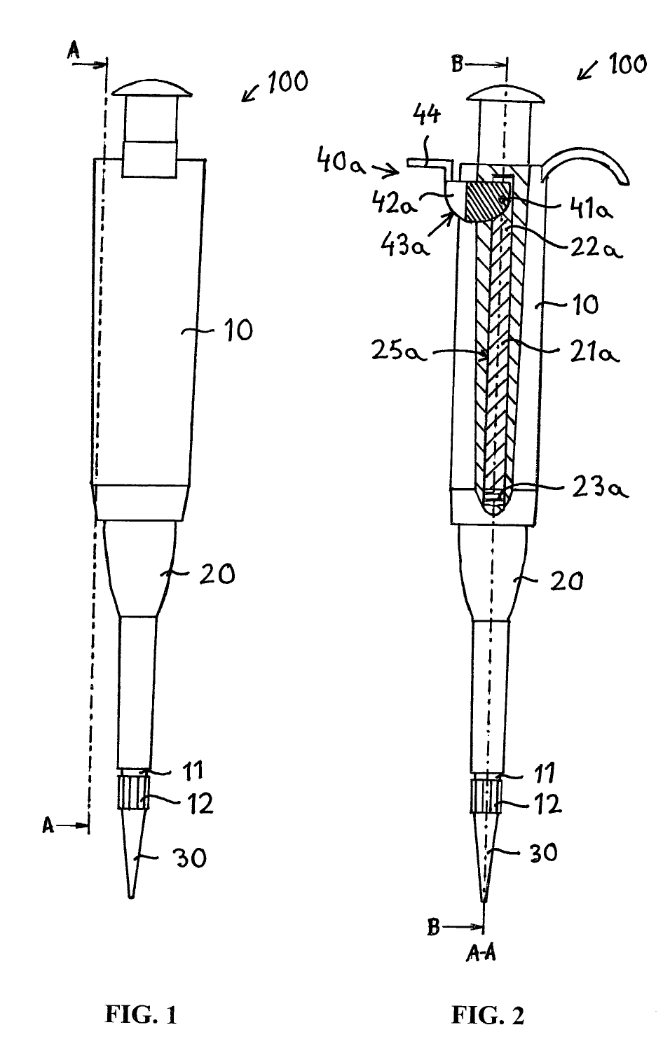

FIG. 1 shows an embodiment of a pipette device;

FIG. 2 shows the pipette device in a side view partially sectioned longitudinally along plane A-A denoted in FIG. 1;

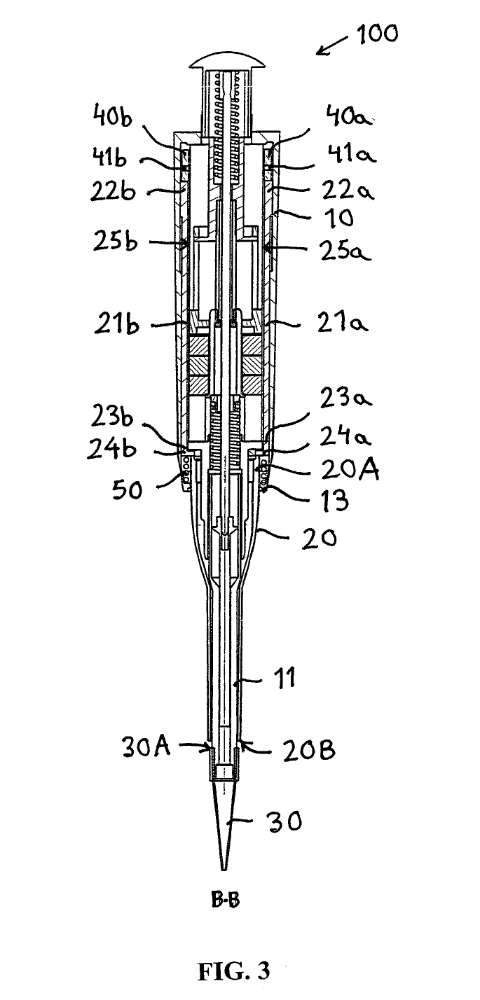

FIG. 3 shows the pipette device in a side view partially sectioned longitudinally along plane B-B denoted in FIG. 2;

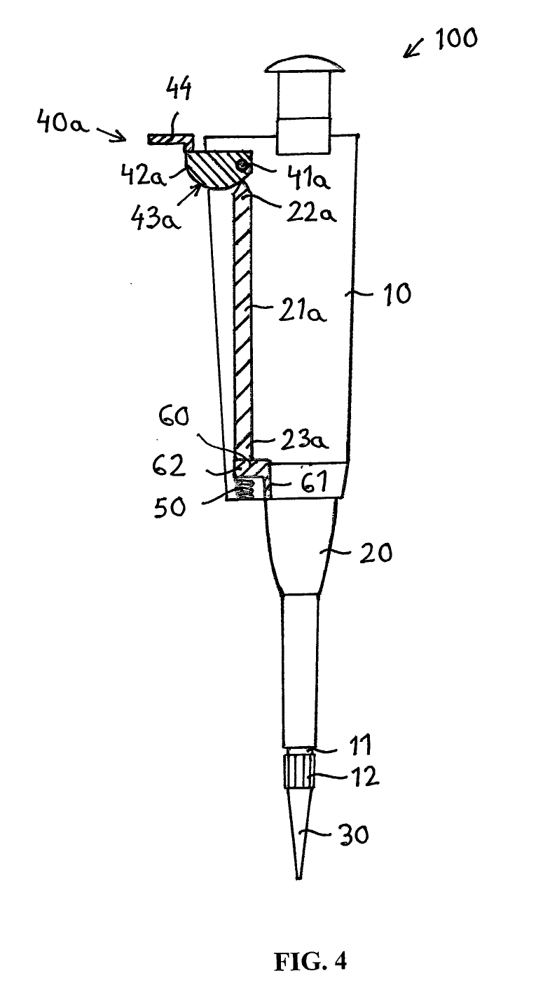

FIG. 4 shows a mechanism according to the invention for the ejection of the disposable pipette tip of a pipette device;

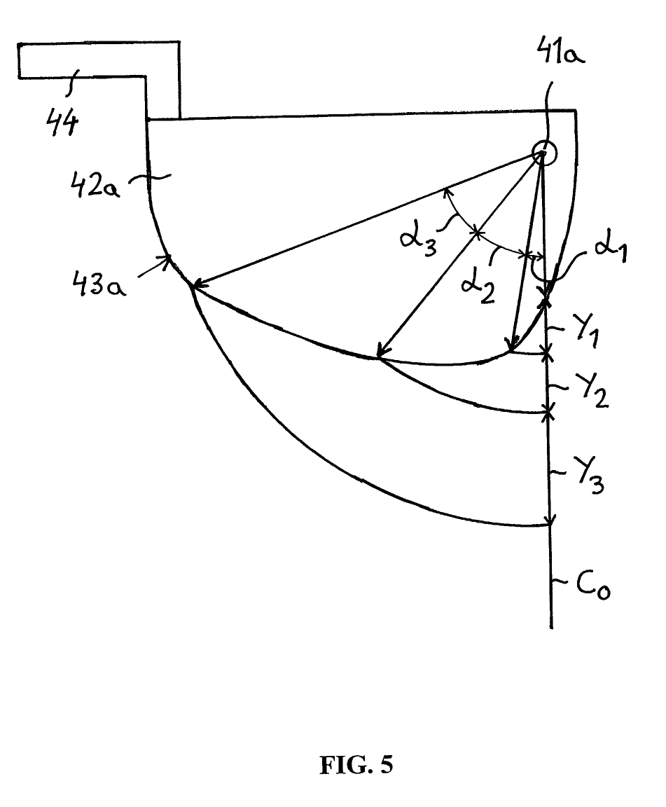

FIG. 5 shows in an enlarged view a preferred embodiment of the cam element employed in a pipette device;

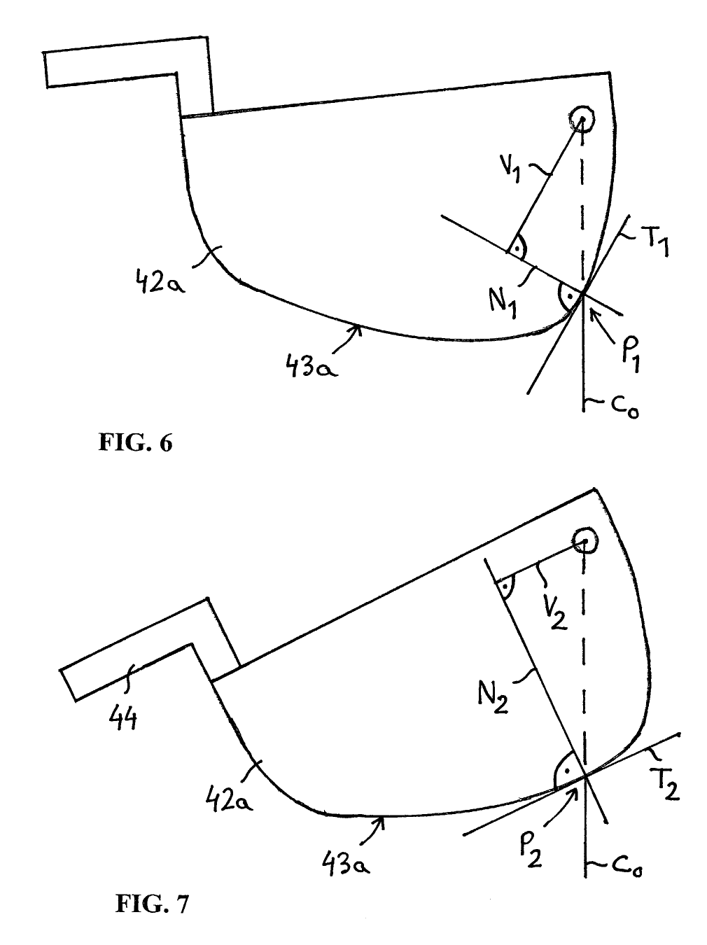

FIG. 6 shows the cam element of FIG. 5 in a position having the cam element rotated slightly forward from its home position; and

FIG. 7 shows the cam element of FIG. 5 in a position having the cam element rotated slightly more forward from its home position.

Equivalent elements in the diagrams are respectively denoted by same reference numerals.

In the diagrams, the pipette device is generally denoted by reference numeral 100.

FIG. 1 illustrates a pipette device 100 comprising a body 10, a tip part 11 of the body 10, an ejector element 20 adapted about the pipette device tip part 11, a frusto-conical distal end 12 of the pipette device tip part 11 and, finally, a disposable pipette tip 30 mounted by a tight friction fit on the frusto-conical distal end 12 of the pipette device tip part 11. In this embodiment, the ejector element is formed by an ejector sleeve 20 adapted to enclose the entire perimeter of the pipette device tip part 11.

FIG. 2 shows the pipette device 100 in a side view partially sectioned longitudinally along plane A-A denoted in FIG. 1. In the diagram is also marked a sectional plane B-B passing along the longitudinal center axis of the pipette device. The purpose of the diagram is to illustrate the means which are associated with the ejection of the disposable pipette tip 30 and are located on the other side of the pipette device above the ejector sleeve 20. These means comprise a first ejector rod 21a aligned parallel to the longitudinal axis of the pipette device 100 and a first actuating member 40a connected to the rod. The first ejector rod 21a is connected by its lower end 23a to an ejector sleeve 20, while its upper end 22a is beveled through rounding the tip of upper end 22a. The first ejector rod 21a is arranged movable in a first slot 25a made in the body 10 in a direction parallel to the longitudinal axis of the pipette device 100. A first actuating member 40a, which is located above the first ejector rod 21a and is connected to the first ejector rod 21a, comprises both a first cam element 42a located in the interior space of body 10 and a toggle lever member 44 extending outwardly from body 10. The first cam element 42a is connected to body 10 at a first pivot point 41a. The cam surface 43a of first cam element 42a contacting the upper end 22a of the first ejector rod 21a is formed by arcuate surface portions. The first pivot point 41a may comprise a pin mounted on the first cam element 42a that fits into a notch or recess made in the body 10 or, alternatively, a pin mounted in the body 10 so as to fit into notch or recess made in the first cam element 42a.

First pivot point 41a and longitudinal center axis of first ejector rod 21a are aligned in the same plane with the longitudinal center axis of the pipette device body 10 so that the first pivot point 41a is located above the upper end 22a of the first ejector rod 21a.

FIG. 3 shows a longitudinally sectional view of the pipette device of FIG. 1 taken along plane B-B denoted in FIG. 2. As can be illustrated in the diagram, the pipette device has the first ejector rod 21a complemented with a second ejector rod 21b and, respectively, the first actuating member 40a complemented with a second actuating member 40b. These ejector rods 21a, 21b with the actuating members 40a, 40b connected thereto are located symmetrically about plane B-B that passes along the longitudinal center axis of the pipette device so that both element-member combinations are situated on opposite sides of body 10. The lower ends 23a, 23b of ejector rods 21a, 21b include projections 24a, 24b directed toward the center axis of the pipette device. The ejector rods 21a, 21b are connected by the inward tips of these projections 24a, 24b to the upper end 20A of ejector sleeve 20. In the space remaining between the underside of projections 24a, 24b of said ejector rods 21a, 21b, the upper side of the top part of ejector sleeve 20 and the interior wall of body 10 is adapted a return spring 50 so that the upper end of return spring 50 rests against the underside of projections 24a, 24b of said ejector rods 21a, 21b, while lower end of return spring 50 rests against a support surface 13 made in body 10. Symmetrically, also the second ejector rod 21b is arranged movable in a second slot 25b made in body 10 in a direction parallel to the longitudinal axis of the pipette device 100. Thus, a line contact is formed between the pointed upper ends 22a, 22b of ejector rods 21a, 21b and the underside surfaces 43a, 43b of cam elements 40a, 40b.

As shown in FIG. 2, the cam elements 40a, 40b of the first actuating member 42a and the second actuating member 42b are connected to each other by a toggle lever member 44 that reaches about body 10 so as to meet the cam elements 42a, 42b, of the first actuating member 40a and the second actuating member 40b. The first 21a and the second ejector rod 21b, as well as the first 42a and the second cam element 42b, respectively, are identical. Advantageously, the cam elements 42a, 42b with the toggle lever member 44 are integrated into one and a single component.

Advantageously, ejector rods 21a, 21b are adapted movable in the interior of the shell of body 10 along slots 25a, 25b made in the interior of the shell of body 10 in a direction parallel to the longitudinal axis of the pipette device 100. Obviously, ejector rods 21a, 21b may also be arranged movable along the exterior side of body 10 or in recesses made to the shell of body 10. Irrespective of their location, ejector rods 21a, 21b must at all times be supported to body 10 so that their movement takes place only parallel to the longitudinal axis of body 10. Friction between ejector rods 21a, 21b and body 10 must be minimized. In practice this requirement can be fulfilled by making ejector rods 21a, 21b from steel, while the guide slots are made in a material of self-lubricating polymer composition.

Obviously, the ejector means may also be implemented so that the ejector rods 21a, 21b are extended up to the distal end 12 of the pipette device tip part 11, whereby the tip part 11 need not be complemented with a separate ejector sleeve 20. In an alternative design the ejector sleeve 20 is continued up to the upper part of pipette device body 10, thus making separate ejector rods 21a, 21b redundant. Herein, the top surface of ejector sleeve 20 may include pointed projections serving to provide a contact point with cam surfaces 43a, 43b of cam elements 42a, 42b.

To the function of the invention it is essential that between cam elements 42a, 42b and proximal end 30A of disposable pipette tip 30 are provided ejector means with the help of which the rotational movement of cam elements 42a, 42b can be transmitted in the direction of the longitudinal center axis of body 10 of pipette device 100 as an ejecting movement inflicted on the disposable pipette tip 30.

The pivot point 41a, 41b of cam elements 42a, 42b on the pipette device body 10 can be implemented so that body 10 is provided with pins projecting from body 10 at pivot points 41a, 41b and cam elements 42a, 42b have a plurality of notches or recesses, whereby the pipette user can select a pivot point most suitable for his/her preference. Obviously, this option may also be implemented in a reverse fashion, whereby cam elements 42a, 42b are provided with plural pins and the pipette device body 10 has compatible notches or recesses only in one position.

Owing to the symmetrical location of ejector rods 21a, 21b adapted movable at opposite sides of the pipette device body 10 in a direction parallel to the longitudinal center axis of the body 10 of the pipette device 100, the ejection force is imposed symmetrically on the ejector sleeve 20 and therefrom further in a uniform fashion to the disposable pipette tip 30 without inflicting torque on body 10 or other structural component of the pipette device 100.

When the pipette device user presses downward the toggle lever member 44 of the pipette tip ejector mechanism, the first cam element 42a and the second cam element 43b are rotated about their respective pivot points 41a, 41b. Resultingly, the arcuate cam surface 43a of the first cam element 42a makes contact to the pointed upper end 22a of the first ejector rod 21a and, respectively, the arcuate cam surface 43b of the second cam element 42b makes contact to the pointed upper end 22b of the second ejector rod 21b. Hereupon, either one of the ejector rods 21a, 21b moves downwardly parallel to the longitudinal center axis of the pipette device 100. Since the lower ends 23a, 23b of ejector rods 21a, 21b are connected to the upper end 20A of ejector sleeve 20, also ejector sleeve 20 is forced to move downward. Resultingly, ejector sleeve 20 moves first a short distance downward before end surface 20B of ejector sleeve 20 meets end top surface 30A of proximal end of disposable pipette tip 30 that is mounted by a tight friction fit on tip part 11 of pipette device 100. When the tip ejector toggle lever 44 is further pressed downward, ejector sleeve 20 will begin ejecting the disposable pipette tip 30 until the pipette tip 30 at the end of the movement finally is detached from the frusto-conical distal end 12 of the pipette device tip part 11.

When the force imposed on the tip ejector toggle lever 44 is removed after the ejection of the disposable pipette tip 30, return spring 50 brings ejector sleeve 20, ejector rods 21a, 21b and tip ejector toggle lever 44 back into their home positions.

In FIG. 4 is shown an embodiment according to the invention that differs from that illustrated in FIGS. 1-3 by having only one actuating member 40a and only one ejector rod 21a. In this embodiment, actuating member 40a and ejector rod 21a are moved from the side of body 10 to the rear portion of body 10. Cam element 42a is connected by pivot point 41a to the rear portion of body 10, e.g., at a forked projection thereof. Respectively, lower end 23a of ejector rod 21a is connected to a support member 60 adapted between ejector sleeve 20 and ejector rod 21a. The support member 60 may comprise, e.g., a ring 61 mounted on the upper end of ejector sleeve 20 and a projection 62 adapted to the rear part of pipette device body 10. Herein, the lower end 22a of ejector rod 21a is connected to projection 62 of support member 60. Between the underside surface of projection 62 of support member 60 and the pipette device body is adapted a return spring 50 serving to bring the ejector elements 20, 21a, 40a back into their home position after the ejection of the disposable pipette tip 30.

This kind of mechanism according to the invention for the ejection of the disposable pipette tip 30 arranged to take place by means of a single actuating member 40a and a single ejector rod 21a may also be implemented so that, of the elements shown in FIGS. 1-3, the second one of the actuating members 40a, 40b and the respective one of ejector rods 21a, 21b making contact thereto is omitted.

Furthermore, the mechanism according to the invention for ejecting of the disposable pipette tip 30 can be arranged to take place by means of a single actuating member 40a, 40b connected to two ejector rods 21a, 21b. In such an arrangement, a ring is adapted to the upper ends of ejector rods 21a, 21b, whereby the ring or a projection made thereto makes contact to cam surface 43a, 43b of the cam element 42a, 42b.

However, the above-described alternative embodiments are hampered by the problem of asymmetric ejection forces discussed earlier in the text. Simply, these arrangements are incapable of imposing symmetrical ejection forces on the proximal end of the disposable pipette tip.

FIG. 5 shows an enlarged view of a preferred embodiment according to the invention of the cam element 42a. In the diagram reference symbol C₀ denotes the longitudinal axis of the ejector rod drawn at the contact point of the ejector rod with the cam surface 43a, while reference symbols α₁, α₂, α₃ are used to denote the angle of rotation of the cam element 42a about its pivot point 41a in different positions of the element. In its initial position, the angle of rotation of cam element 42a is 0°, whereby the lower end of the ejector sleeve is still at a distance from the proximal end of the disposable pipette tip. In the illustrated situation having cam element 42a rotated about pivot point 41a by angle α₁, the lower end of the ejector sleeve meets the proximal end of the disposable pipette tip and the actual ejection of the disposable tip may begin. Inasmuch the travel required to drive the lower end of the ejector sleeve from its home position down into contact with the proximal end of the disposable pipette tip needs no major force, the radial contour of cam surface 43a can be made abruptly changing in regard to pivot point 41a so that the required ejector rod travel Y₁ downward is achieved by virtue of actuating cam surface 42a over a small angle α₁. The next actuation step in the pipette operation requires a great force to overcome static friction holding the disposable pipette tip on the pipette device tip part so as to detach the disposable pipette tip. This step takes place when the cam element 42a is rotated by angle α₂. Around this angular range, the radial contour of cam element surface 43a in regard to its pivot point 41a changes slightly so that a large angle of rotation α₂ causes only a small vertical ejector rod travel Y₂. After the static friction between the pipette device tip part and the disposable pipette tip is overcome and ejection of the disposable tip has begun, a reduced force is sufficient for pushing the disposable tip apart from the pipette device tip part thus allowing the radial contour of cam element surface 43a to change again more abruptly in regard to its pivot point 41a. Hence, the final increment of the angle of rotation α₃ of cam element 42a can be used for exerting a longer stroke Y₃ to complete the vertical ejector rod travel.

The design of cam element 42a shown in FIG. 5 is capable of transmitting the force applied by the pipette device user to the ejector toggle lever 44 further to ejector rod 21a at an optimized torque conversion ratio over the critical angle of rotation α₂ of cam element 42a where force is needed to overcome static friction between the disposable pipette tip 30 and the pipette device tip part 11.

FIGS. 6 and 7 show the cam element 42a in two different angular positions. In FIG. 6, the contact point P₁ between the cam surface 43a and the upper end of the ejector rod is located approximately in the middle of the first angular range α₁ drawn in FIG. 5, while in FIG. 7 the contact point P₂ between the cam surface 43a and the upper end of the ejector rod is approximately in the middle of the second angular range α₂ drawn in FIG. 5. The vector direction of the force imposed by cam surface 43a on the upper end of the ejector rod is denoted by the normal N₁, N₂ drawn perpendicular to tangent T₁, T₂ at the instantaneous contact point P₁, P₂ between the cam surface 43a and the upper end 22a of ejector rod 21a. The virtual lever arm V₁, V₂ of the applied force is the orthogonal distance of force vector N₁, N₂ from pivot point 41a. As is evident from the diagrams, virtual lever arm V₂ in FIG. 7 is shorter than virtual lever arm V₁ in FIG. 6. Resultingly, the upper end of the ejector rod receives in the configuration of FIG. 7 a higher force than in the configuration of FIG. 6 assuming that ejector toggle lever 44 is pressed by a constant force.

Hence, the contour of the cam surfaces 43a, 43b of cam elements 42a, 42b and the shape of the upper ends 22a, 22b of ejector rods 21a, 21b can be designed so that the relationship between the travel of ejector rods 21a, 21b in the direction of the longitudinal center axis of pipette device body 10 and the angular rotation of toggle lever 44 is optimized in a desired fashion. By way of varying the above-mentioned design parameters, it is also possible to adjust the force imposed on proximal end 30A of disposable pipette tip 30 via ejector sleeve 20 moved by ejector rods 21a, 21b as a function of the angular rotation of ejector toggle lever 44 in a fashion that performs the ejection of the disposable pipette tip 30 optimally.

The movement of the ejector rods 21a, 21b in the direction of the longitudinal axis of pipette device 100 may be arranged to occur in a one-to-one, reduced or amplified proportion to the angle of rotation of ejector toggle lever 44. Furthermore, the motion of ejector rods 21a, 21b can include one or more discontinuity points, e.g., such at which ejector rods 21a, 21b remain stationary during the movement of the ejector toggle lever 44. Moreover, the movement of ejector rods 21a, 21b may comprise a combination of such continuous and/or discontinuous movements.

In the embodiments shown in the diagrams, pivot points 41a, 41b of cam elements 42a, 42b are located at central axes C₀ of ejector rods 21a, 21b. This design is advantageous in terms of the actuating torque forces. However, the arrangement is not obligatory to the function of the invention. Pivot points 41a, 41b may also be located aside from said longitudinal center axis C₀ of ejector rods 21a, 21b.

The embodiments shown in the diagrams represent the most typical design, wherein the disposable pipette tip 30 is pushed home onto the distal end 12 of the pipette device tip part 11. The invention is also applicable in an inverted design, wherein the disposable pipette tip 30 is insertable into the distal end 12 of the pipette device tip part 11. Herein, the ejector means operating between the actuating members 40a, 40b and the disposable pipette tip 30 must be adapted into the interior space of the pipette device 100, whereby the pipette piston and piston rod may also be arranged to function as the ejector means of the disposable pipette tip.

1. A pipette device comprising a body (10) with a tip part (11), said tip part (11) having a distal end (12) suited for mounting thereon a disposable pipette tip (30) by a tight friction fit, tip ejector means (20; 21a, 21b) adapted to perform a movement in the direction of the longitudinal axis of the pipette device (100) between the distal end (30A) of the disposable pipette tip (30) and the upper portion of the body (10), and at least one actuating means (40a, 40b) located in the upper portion of the body (10) and cooperating with said pipette tip ejector means (20; 21a, 21b) so as to accomplish said movement of said tip ejector means (20, 21a, 21b) in the direction of the longitudinal axis of said pipette device (100), characterized in that said at least one actuating means (40a, 40b) comprises a cam element (42a, 42b) connected to the body (10) of the pipette device (100) by means of a pivotal joint (41a, 41b) and having an at least partially arcuate cam surface (43a, 43b) suited to make contact with the top surface (22a, 22b) of said pipette tip ejector means (20; 21a, 21b) so as to move said pipette tip ejector means (20; 21a, 21b) in the direction of the longitudinal axis of the pipette device (100) for ejecting said disposable pipette tip (30) from the distal end (12) of said pipette device tip part (11).

2. The pipette device of claim 1, characterized in that the pipette device additionally comprises a spring element (50) suited for returning said pipette tip ejector means (20; 21a, 21b) and said at least one actuating means (40a, 40b) into their home positions after the ejection of the disposable pipette tip (30).

3. The pipette device of claim 1 or 2, characterized in that the pipette device includes two actuating means (40a, 40b), each one of which comprising a cam element (42a, 42b) that are mounted on the pipette device body (10) by means of a pivotal joint (41a, 41b), are adapted to operate on the opposite sides of the pipette device body (10) and have an at least partially arcuate cam surface (43a, 43b) suited to make contact with the top surface (22a, 22b) of said pipette tip ejector means (20; 21a, 21b) so as to move said pipette tip ejector means (20; 21a, 21b) in the direction of the longitudinal axis of the pipette device (100) for ejecting said disposable pipette tip (30) from the distal end (12) of the pipette device tip part (11).

4. The pipette device of claim 3, characterized in that said pipette tip ejector means (20; 21a, 21b) comprise an ejector sleeve (20) adapted movable on the pipette device tip part (11) in a direction parallel to the longitudinal axis of the pipette device (100) so that the lower end (20B) of the ejector sleeve (20) can be brought into contact with the proximal end (30A) of the disposable pipette tip (30) and further comprise ejector rods (21a, 21b) located on opposite sides of the pipette device body (10) and adapted movable in a direction parallel to the longitudinal axis of the pipette device (100) with their lower ends (23a, 23b) being connected to the upper end (20A) of ejector sleeve (20) and their upper ends (22a, 22b) being in contact with the cam element surfaces (43a, 43b) of said cam elements (42a, 42b).

5. The pipette device of claim 4, characterized in that the ejector rods (21a, 31b) are adapted into slots (25a, 25b) made in the pipette device body (10) so as to allow the movement of said ejector rods (21a, 21b) in a direction parallel to the longitudinal axis of the pipette device (100).

6. The pipette device of claim 5, characterized in that the lower ends (23a, 23b) of ejector rods (21a, 21b) are provided with projections (24a, 24b) directed toward the center axis of the pipette device so that the inward tips of the projections are connected to the upper end (20A) of ejector sleeve (20).

7. The pipette device of claim 6, characterized in that said spring element (50) is adapted into the space remaining between the underside of projections (24a, 24b) of the lower ends (23a, 23b) of ejector rods (21a, 21b), the exterior surface of the upper end (20A) of ejector sleeve (20) and the interior wall of pipette device body (10) so that the upper end of the spring element (50) rests against the underside of said projections (24a, 24b), while the lower end of the spring element rests against a support surface (13) made in the pipette device body (10).

8. The pipette device of claim 7, characterized in that the upper ends (22a, 22b) of ejector rods (21a, 21b) are V-shaped with a rounded tip.

9. The pipette device of any one of claims 4-8, characterized in that the center of pivot points (41a, 41b) of cam elements (42a, 42b) is located at the longitudinal center axis of ejector rods (21a, 21b), whereby the contact point of the cam element surfaces (43a, 43b) of cam elements (42a, 42b) with the upper ends (22a, 22b) of ejector rods (21a, 21b) is also located at the longitudinal center axis of ejector rods (21a, 21b).

10. The pipette device of any one of claims 4-9, characterized in that the cam elements (42a, 42b) of actuating means (40a, 40b) located symmetrically on opposite sides of the pipette device body (10) are connected to each other by a toggle lever member (44) arranged to project outwardly from the pipette device body (10) so as to provide an ejector toggle lever of the disposable pipette tip (30) for the user of the pipette device.

11. The pipette device of any one of claims 4-10, characterized in that the contour of cam element surfaces (43a, 43b) of cam elements (42a, 42b) is designed so as to maximize the ratio of the force imposed by ejector rods (21a, 21b) on ejector sleeve (20) to the force applied to the ejector toggle lever (44) in the position of the ejector sleeve (20) wherein ejector sleeve (20) meets the proximal end (30A) of the disposable pipette tip (30).
